(19) United States
(12) Patent Application Publication
(10) Pub. No.: US 2026/0136297 A1
(43) Pub. Date: May 14, 2026

(54) MECHANISMS FOR ARTIFICIAL INTELLIGENCE/MACHINE LEARNING BASED CLOSED LOOP TRANSMIT POWER CONTROL

(71) Applicant: QUALCOMM Incorporated, San Diego, CA (US)

(72) Inventors: Qing LI, Princeton Junction, NJ (US); Junyi LI, Greentown, PA (US)

(21) Appl. No.: 18/948,272

(22) Filed: Nov. 14, 2024

(51) Int. Cl. H04W 52/08; H04W 52/14

(52) U.S. Cl. CPC H04W 52/08; H04W 52/146

(57) ABSTRACT

Methods, systems, and devices for wireless communications are described. A user equipment (UE) may receive a transmit power control (TPC) command identifying a closed loop TPC parameter associated with an uplink transmit power level for an uplink transmission. The UE may perform the uplink transmission at a modified uplink transmit power level according to the closed loop TPC parameter and a closed loop transmit power adjustment, wherein the closed loop transmit power adjustment modifies the closed loop TPC parameter according to a set of input parameters associated with the UE.

### FIELD OF TECHNOLOGY

The following relates to wireless communications, including mechanisms for artificial intelligence/machine learning based closed loop transmit power control.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a transmit power control (TPC) command identifying a closed loop TPC parameter associated with an uplink transmit power level for an uplink transmission and performing the uplink transmission at a modified uplink transmit power level according to the closed loop TPC parameter and a closed loop transmit power adjustment, where the closed loop transmit power adjustment modifies the closed loop TPC parameter according to a set of input parameters associated with the UE.

A UE for wireless communications is described. The UE may include one or more memories storing processor executable code, and one or more processors coupled with the one or more memories. The one or more processors may individually or collectively be operable to execute the code to cause the UE to receive a TPC command identifying a closed loop TPC parameter associated with an uplink transmit power level for an uplink transmission and perform the uplink transmission at a modified uplink transmit power level according to the closed loop TPC parameter and a closed loop transmit power adjustment, where the closed loop transmit power adjustment modifies the closed loop TPC parameter according to a set of input parameters associated with the UE.

Another UE for wireless communications is described. The UE may include means for receiving a TPC command identifying a closed loop TPC parameter associated with an uplink transmit power level for an uplink transmission and means for performing the uplink transmission at a modified uplink transmit power level according to the closed loop TPC parameter and a closed loop transmit power adjustment, where the closed loop transmit power adjustment modifies the closed loop TPC parameter according to a set of input parameters associated with the UE.

A non-transitory computer-readable medium storing code for wireless communications is described. The code may include instructions executable by one or more processors to receive a TPC command identifying a closed loop TPC parameter associated with an uplink transmit power level for an uplink transmission and perform the uplink transmission at a modified uplink transmit power level according to the closed loop TPC parameter and a closed loop transmit power adjustment, where the closed loop transmit power adjustment modifies the closed loop TPC parameter according to a set of input parameters associated with the UE.

In some examples of the method, user equipment (UEs), and non-transitory computer-readable medium described herein, the set of input parameters include one or more of a radio link status, a physical environment parameter, a data traffic characteristics, UE information, and one or more artificial intelligence/machine learning (AI/ML) parameters.

In some examples of the method, user equipment (UEs), and non-transitory computer-readable medium described herein, modifying the closed loop TPC parameter may include operations, features, means, or instructions for selecting a maximum uplink transmit power level as the modified uplink transmit power level based on a function of the closed loop TPC parameter and the closed loop transmit power adjustment.

In some examples of the method, user equipment (UEs), and non-transitory computer-readable medium described herein, modifying the closed loop TPC parameter may include operations, features, means, or instructions for selecting a minimum uplink transmit power level as the modified uplink transmit power level based on a function of the closed loop TPC parameter and the closed loop transmit power adjustment.

In some examples of the method, user equipment (UEs), and non-transitory computer-readable medium described herein, modifying the closed loop TPC parameter may include operations, features, means, or instructions for performing an additive function to select the modified uplink transmit power level, where the additive function may be according to the closed loop TPC parameter and on the closed loop transmit power adjustment.

In some examples of the method, user equipment (UEs), and non-transitory computer-readable medium described herein, modifying the closed loop TPC parameter may include operations, features, means, or instructions for performing a scaling function to select the modified uplink transmit power level, where the scaling function applies a scaling factor to the closed loop TPC parameter, where the scaling factor may be based on the closed loop transmit power adjustment.

Some examples of the method, user equipment (UEs), and non-transitory computer-readable medium described herein may further include operations, features, means, or instructions for transmitting a UE capability message indicating support for modifying the closed loop TPC parameter according to the closed loop transmit power adjustment.

Some examples of the method, user equipment (UEs), and non-transitory computer-readable medium described herein may further include operations, features, means, or instructions for receiving a reconfiguration or activation message identifying one or more updates to the set of input parameters, where modifying the closed loop TPC parameter may be according to the one or more updates to the set of input parameters.

Some examples of the method, user equipment (UEs), and non-transitory computer-readable medium described herein may further include operations, features, means, or instructions for receiving an activation message that activates or deactivates modification of the closed loop TPC parameter using the closed loop transmit power adjustment.

Some examples of the method, user equipment (UEs), and non-transitory computer-readable medium described herein may further include operations, features, means, or instructions for receiving a fallback message that sets the closed loop transmit power adjustment to a baseline value.

Some examples of the method, user equipment (UEs), and non-transitory computer-readable medium described herein may further include operations, features, means, or instructions for receiving a control message that identifies an uplink transmission instance during which the uplink transmission may be performed according to the closed loop TPC parameter and the closed loop transmit power adjustment.

A method for wireless communications by a network entity is described. The method may include transmitting, to a UE, a TPC command identifying a closed loop TPC parameter associated with an uplink transmit power level for an uplink transmission from the UE and receiving the uplink transmission transmitted at to a modified uplink transmit power level according to the closed loop TPC parameter and a closed loop transmit power adjustment, where the closed loop transmit power adjustment modifies the closed loop TPC parameter according to a set of input parameters associated with the UE.

A network entity for wireless communications is described. The network entity may include one or more memories storing processor executable code, and one or more processors coupled with the one or more memories. The one or more processors may individually or collectively be operable to execute the code to cause the network entity to transmit, to a UE, a TPC command identifying a closed loop TPC parameter associated with an uplink transmit power level for an uplink transmission from the UE and receive the uplink transmission transmitted at to a modified uplink transmit power level according to the closed loop TPC parameter and a closed loop transmit power adjustment, where the closed loop transmit power adjustment modifies the closed loop TPC parameter according to a set of input parameters associated with the UE.

Another network entity for wireless communications is described. The network entity may include means for transmitting, to a UE, a TPC command identifying a closed loop TPC parameter associated with an uplink transmit power level for an uplink transmission from the UE and means for receiving the uplink transmission transmitted at to a modified uplink transmit power level according to the closed loop TPC parameter and a closed loop transmit power adjustment, where the closed loop transmit power adjustment modifies the closed loop TPC parameter according to a set of input parameters associated with the UE.

A non-transitory computer-readable medium storing code for wireless communications is described. The code may include instructions executable by one or more processors to transmit, to a UE, a TPC command identifying a closed loop TPC parameter associated with an uplink transmit power level for an uplink transmission from the UE and receive the uplink transmission transmitted at to a modified uplink transmit power level according to the closed loop TPC parameter and a closed loop transmit power adjustment, where the closed loop transmit power adjustment modifies the closed loop TPC parameter according to a set of input parameters associated with the UE.

In some examples of the method, network entities, and non-transitory computer-readable medium described herein, the set of input parameters include one or more of a radio link status, a physical environment parameter, a data traffic characteristics, UE information, and one or more AI/ML parameters.

In some examples of the method, network entities, and non-transitory computer-readable medium described herein, modification of the closed loop TPC parameter may be according to a selection of a maximum uplink transmit power level as the modified uplink transmit power level based on a function of the closed loop TPC parameter and the closed loop transmit power adjustment.

In some examples of the method, network entities, and non-transitory computer-readable medium described herein, modification of the closed loop TPC parameter may be according to a selection of a minimum uplink transmit power level as the modified uplink transmit power level based on a function of the closed loop TPC parameter and the closed loop transmit power adjustment.

In some examples of the method, network entities, and non-transitory computer-readable medium described herein, modification of the closed loop TPC parameter may be according to a performance of an additive function to select the modified uplink transmit power level and the additive function may be according to the closed loop TPC parameter and on the closed loop transmit power adjustment.

In some examples of the method, network entities, and non-transitory computer-readable medium described herein, modification of the closed loop TPC parameter may be according to a performance of a scaling function to select the modified uplink transmit power level, the scaling function applies a scaling factor to the closed loop TPC parameter, and the scaling factor may be based on the closed loop transmit power adjustment.

Some examples of the method, network entities, and non-transitory computer-readable medium described herein may further include operations, features, means, or instructions for receiving a UE capability message indicating support for modifying the closed loop TPC parameter according to the closed loop transmit power adjustment.

Some examples of the method, network entities, and non-transitory computer-readable medium described herein may further include operations, features, means, or instructions for transmitting a reconfiguration or activation message identifying one or more updates to the set of input parameters, where modifying the closed loop TPC parameter may be according to the one or more updates to the set of input parameters.

Some examples of the method, network entities, and non-transitory computer-readable medium described herein may further include operations, features, means, or instructions for transmitting an activation message that activates or deactivates modification of the closed loop TPC parameter using the closed loop transmit power adjustment.

Some examples of the method, network entities, and non-transitory computer-readable medium described herein may further include operations, features, means, or instructions for transmitting a fallback message that sets the closed loop transmit power adjustment to a baseline value.

Some examples of the method, network entities, and non-transitory computer-readable medium described herein may further include operations, features, means, or instructions for transmitting a control message that identifies an uplink transmission instance during which the uplink transmission may be performed according to the closed loop TPC parameter and the closed loop transmit power adjustment.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports mechanisms for artificial intelligence/machine learning (AI/ML) based closed loop transmit power control in accordance with one or more aspects of the present disclosure.

FIG. 2 shows an example of a wireless communications system that supports mechanisms for AI/ML based closed loop transmit power control in accordance with one or more aspects of the present disclosure.

FIG. 3 shows an example of a TPC configuration that supports mechanisms for AI/ML based closed loop transmit power control in accordance with one or more aspects of the present disclosure.

FIG. 4 shows an example of a TPC configuration that supports mechanisms for AI/ML based closed loop transmit power control in accordance with one or more aspects of the present disclosure.

FIGS. 5 and 6 show block diagrams of devices that support mechanisms for AI/ML based closed loop transmit power control in accordance with one or more aspects of the present disclosure.

FIG. 7 shows a block diagram of a communications manager that supports mechanisms for AI/ML based closed loop transmit power control in accordance with one or more aspects of the present disclosure.

FIG. 8 shows a diagram of a system including a device that supports mechanisms for AI/ML based closed loop transmit power control in accordance with one or more aspects of the present disclosure.

FIGS. 9 and 10 show block diagrams of devices that support mechanisms for AI/ML based closed loop transmit power control in accordance with one or more aspects of the present disclosure.

FIG. 11 shows a block diagram of a communications manager that supports mechanisms for AI/ML based closed loop transmit power control in accordance with one or more aspects of the present disclosure.

FIG. 12 shows a diagram of a system including a device that supports mechanisms for AI/ML based closed loop transmit power control in accordance with one or more aspects of the present disclosure.

FIGS. 13 through 16 show flowcharts illustrating methods that support mechanisms for AI/ML based closed loop transmit power control in accordance with one or more aspects of the present disclosure.

### DETAILED DESCRIPTION

Wireless networks may utilize transmit power control (TPC) commands to achieve a desired uplink receive power level at the network entity. The TPC command may be used by user equipment (UE) to identify or otherwise determine an uplink transmit power level to be applied for an uplink transmission during an uplink transmission instance. The UE may perform the uplink transmission at the selected uplink transmit power level and the network entity may measure the received power level that the uplink transmission was received at. The network entity may update the TPC command for subsequent uplink transmissions from the UE. However, in some cases the channel conditions between the UE and the network entity may change between uplink transmission instances, which may result in the next TPC command being stale. That is, the next TPC command may be based on channel conditions that are no longer current for the UE-to-network entity uplink transmissions.

Accordingly, aspects of the techniques described herein provide for a closed loop TPC power adjustment to be applied as part of the closed loop TPC operations of the UE. The closed loop TPC power adjustment may be based on artificial intelligence/machine learning (AL-ML) being used to update the TPC command provided to the UE. For example, the UE may receive or otherwise obtain a TPC command from a network entity. The TPC command may identify a closed loop TPC parameter that the UE may use for determining an uplink transmit power level for an uplink transmission. The UE may perform the uplink transmission to the network entity at a modified uplink transmit power level. The modified uplink transmit power level may be according to or otherwise based on the closed loop TPC and the closed loop transmit power adjustment (e.g., based on the AI/ML input being used to modify the TPC command). In some aspects, the closed loop transmit power adjustment may be used to modify the closed loop TPC parameter using a set of input parameters (e.g., AI/ML parameters) associated with the UE.

Aspects of the disclosure are initially described in the context of wireless communications systems. Aspects of the disclosure are further illustrated by and described with reference to apparatus diagrams, system diagrams, and flowcharts that relate to mechanisms for AI/ML based closed loop transmit power control.

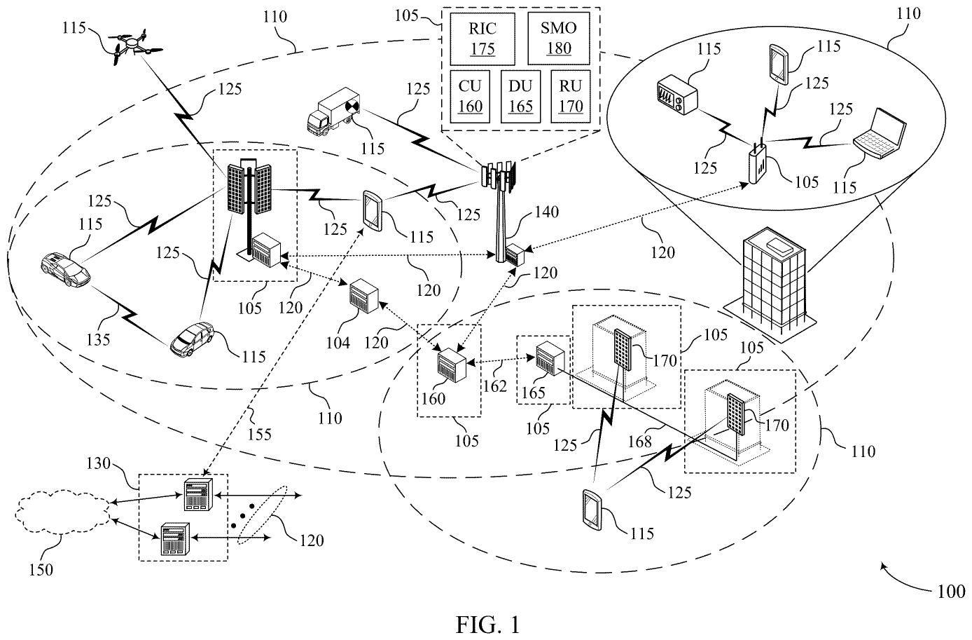

FIG. 1 shows an example of a wireless communications system 100 that supports mechanisms for AI/ML based closed loop transmit power control in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support mechanisms for AI/ML based closed loop transmit power control as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Af) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may receive a TPC command identifying a closed loop TPC parameter associated with an uplink transmit power level for an uplink transmission. The UE 115 may perform the uplink transmission at a modified uplink transmit power level according to the closed loop TPC parameter and a closed loop transmit power adjustment, wherein the closed loop transmit power adjustment modifies the closed loop TPC parameter according to a set of input parameters associated with the UE 115.

A network entity 105 may transmit, to a UE 115, a TPC command identifying a closed loop TPC parameter associated with an uplink transmit power level for an uplink transmission from the UE 115. The network entity 105 may receive the uplink transmission transmitted at to a modified uplink transmit power level according to the closed loop TPC parameter and a closed loop transmit power adjustment, wherein the closed loop transmit power adjustment modifies the closed loop TPC parameter according to a set of input parameters associated with the UE 115.

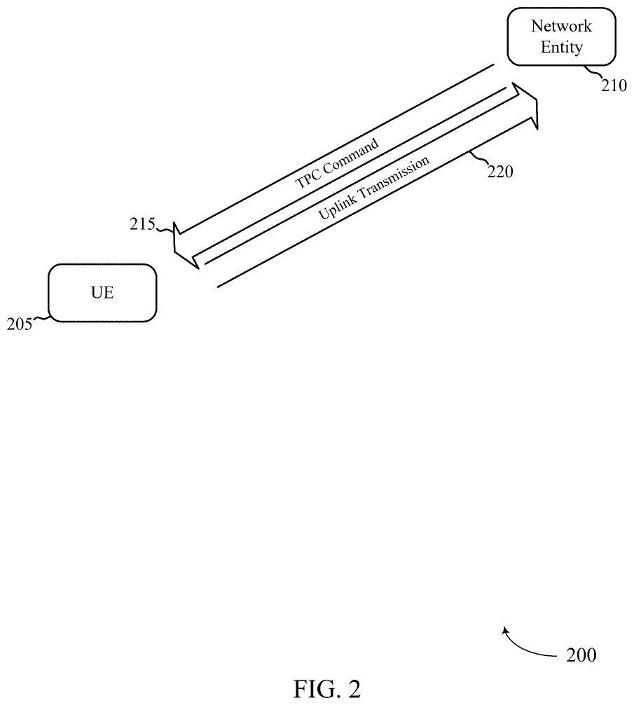

FIG. 2 shows an example of a wireless communications system 200 that supports mechanisms for AI/ML based closed loop transmit power control in accordance with one or more aspects of the present disclosure. The wireless communications system 200 may implement aspects of or be implemented by aspects of the wireless communications system 100. The wireless communications system 200 may include a UE 205 and a network entity 210, which may be examples of the corresponding devices described herein.

Wireless networks may use various techniques to manage or otherwise control the amplitude of wireless signals transmitted over the wireless channels. These techniques may be based on a desired transmit power level (e.g., from the transmitter) or on a desired receive power level (e.g., at the receiver). One such example includes TPC techniques designed to achieve, at least in part, a desired receive power level at the network entity from an uplink transmission from a UE. For example, the UE may transmit an uplink transmission (e.g., a physical uplink shared channel (PUSCH) transmission) on an active uplink bandwidth part (BWP) b of carrier f of serving cell c using a parameter set configuration with index j and PUSCH power control adjustment state with index 1. If the UE is indicated with a first TCI uplink state and a second TCI state or TCI uplink state and is configured with a multipanelScheme information element (IE), and the UE determines to apply both the first TCI uplink state and the second TCI state or TCI uplink state in PUSCH transmission occasion i, the UE may determine the PUSCH transmission power P_{PUSCH,b,f,c,k} (i, j, q_{d}, l) for the k-th indicated TCI state or TCI uplink state according to:

$${P}_{PUSCH , b , f , c , k} ( i , j , {q}_{d} , l ) = min \{ \begin{matrix}{P}_{CMAX , f , c , k} ( i ) \\ {P}_{{O}_{PUSCH} , b , f , c} ( j ) + {α}_{b , f , c} ( j ) \cdot {PL}_{b , f , c} ( {q}_{d} ) + 10 {log}_{10} ( {2}^{μ} \cdot {M}_{RB , b , f , c}^{PUSCH} ( i ) ) + {Δ}_{TF , b , f , c} ( i ) + {f}_{b , f , c} ( i , l )\end{matrix} \}$$

in dBm where j=0 is for Message 3 or Message A in random access, or PUSCH when P0-PUSCH-AlphaSet is not provided, j=1 is for configured grant and j≥2 is for dynamic grant; P_{CMAX,f,c,k} (i) is the UE configured maximum output power for a transmission instance i; P_{O}_{_{PUSCH}}_{,b,f,c}(j)=P_{O_NOMINAL,PUSCH,f,c}(j)+P_{O_UE_PUSCH,b,f,c}(j) is a target receiving power at gNB for a transmission configuration index j, when allocated a single resource block (RB) with 15 kHz subcarrier spacing and 0 dB pathloss; a_{b,f,c}(j) is a scaling factor of pathloss for a transmission configuration index j; PL_{b,f,c} (q_{d}) is the pathloss measured with the RS (index q_{d});

$${M}_{RB , b , f , c}^{PUSCH} ( i )$$

is the PUSCH resource assignment in number of resource blocks as indicated in DCI for a transmission instance i;

$${Δ}_{TF} ( i ) = 10 {log}_{10} ( ( {2}^{BPRE \cdot {K}_{s}} - 1 ) \cdot {β}_{offset}^{PUSCH} )$$

for Kₛ=1.25 and Δ_{TF,b,f,c}(i)=0 for Kₛ=0 (Kₛ is provided by deltaMCS), for a transmission instance i; and f_{b,f,c}(i, l) is the close-loop power control command indicated in DCI for transmission instance i and power control adjustment state 1.

That is, the term

$${α}_{b , f , c} ( j ) \cdot {PL}_{b , f , c} ( {q}_{d} ) + 10 {log}_{10} ( {2}^{μ} \cdot {M}_{RB , b , f , c}^{PUSCH} ( i ) ) + {Δ}_{TF , b , f , c} ( i )$$

generally refers to the open loop TPC while the term fb, (i, l) generally refers to the closed loop TPC (e.g., based on the closed loop power control command indicated in the DCI).

However, this approach may result in stale TPC commands being provided to the UE in some situations. For example, in some situations a closed loop power control command indicated in DC for transmission instance i and power control adjustment state l, f_{b,f,c} (i, l), may be based on previous uplink transmissions (e.g., transmission instance i−1 or earlier transmission instance for power control adjustment state l). If the radio channel changes dynamically during the time (Δt) between transmission instances, the closed loop power control command is not accurate (e.g., is stale). For example, inaccurate power adjustments may cause a “ping-pong” effect between increasing power and decreasing power (e.g., with over adjustment) or slow power change (e.g., with under adjustment), which may cause unnecessary interference and power waste or performance degradation.

In some wireless networks the data traffic characteristics may be more diversified (e.g., more dynamic packet burst patterns), which may cause large variations of the time (Δt) between transmission instances. Such networks may support mega MIMO protocols with much narrower beams and, therefore, the beam gain may vary with beam alignment (e.g., far field) or beam focusing (e.g., near field). In some networks, the radio channel within frequency range two (FR2) or frequency range three (FR3) may have more dynamic attenuation.

Accordingly, aspects of the techniques described herein may be based on the data collected on the UE-side enabling smart implementation and AI/ML capabilities that further empowers a smart UE to make better decisions for the transmit power control. Such techniques may provide for enabling more optimized closed loop transmit power control with the support of AI/ML capabilities that meet more diverse traffic requirements. Aspects of the techniques described herein provide for a closed loop transmit power adjustment ΔP_{b,f,c} (i, l) (e.g., a power adjustment for transmission instance i and power control adjustment state l) that may be predicted or determined via an AI/ML inference.

For example, at 215 the network entity 210 may transmit or otherwise output (and the UE 205 may receive or otherwise obtain) a TPC command that defines or otherwise identifies a closed loop TPC parameter associated with an uplink transmit power level for an uplink transmission. For example, the closed loop TPC parameter may correspond to or otherwise be associated with f_{b,f,c}(i, l).

At 220 the UE 205 may transmit or otherwise output (and the network entity 210 may receive or otherwise obtain) the uplink transmission at a modified uplink transmit power level according to the closed loop TPC parameter and a closed loop transmit power adjustment (e.g., ΔP_{b,f,c} (i, l)). The closed loop transmit power adjustment may modify the closed loop TPC parameter according to a set of input parameters associated with the UE 205 (e.g., to obtain the modified uplink transmit power level). For example, the closed loop uplink transmit power level may be a function of ΔP_{b,f,c} (i, l) and f_{b,f,c} (i, l) (e.g., F(ΔP_{b,f,c} (i, l), f_{b,f,c} (i, l))), which may be further optimized for quality of service (QoS) and energy considerations.

As one example, the transmit power boost for a packet transmission with closed loop transmit power adjustment may, for example, include a closed loop transmit power=max {ΔP_{b,f,c} (i, l), f_{b,f,c} (i, l)} (e.g., a max function for the F( )). That is, the UE 205 may modify the closed loop TPC parameter by selecting a maximum uplink transmit power level as the modified uplink transmit power level based on or according to a function of the closed loop TPC parameter and the closed loop transmit power adjustment (e.g., select the higher uplink transmit power level). For a service with higher priority or reliability, low latency, or higher energy budget or allocation, this approach may provide a packet with a higher reliability for more reliable decoding, with a lower latency to avoid retransmissions for timely transmissions, among other benefits. For example, this approach may be applied for high-priority, high-reliability, or low-latency packet transmissions.

As another example, the transmit power reduction for a packet transmission with a closed loop transmit power adjustment may, for example, include a closed loop transmit power adjustment=min {ΔP_{b,f,c} (i, l), f_{b,f,c} (i, l)} (e.g., a min function for the F( )). That is, the UE 205 may modify the closed loop TPC parameter by selecting a minimum uplink transmit power level as the modified uplink transmit power level based on or according to a function of the closed loop TPC parameter and the closed loop transmit power adjustment. For a service with lower priority or reliability, higher latency, or lower energy budget or allocation, this approach may provide a packet with a lower reliability level, a higher latency, with a lower energy consumption or a lower interference level, among other benefits. For example, this approach may be applied to low-priority, low-reliability, high-latency, or low energy packet transmissions.

As another example, the closed loop transmit power may be a function of ΔP_{b,f,c} (i, l) (e.g., the closed loop transmit power adjustment) and f_{b,f,c} (i, l) (e.g., the closed loop TPC parameter). That is, the closed loop transmit power may be identified or otherwise selected according to F(ΔP_{b,f,c} (i, l), f_{b,f,c} (i, l)), which may be a combination of ΔP_{b,f,c} (i, l) and f_{b,f,c} (i, l). For example, the closed loop transmit power may={ΔP_{b,f,c} (i, l)+f_{b,f,c} (i, l)} (e.g., an addition function for the F( )), where the ΔP_{b,f,c} (i, l) and f_{b,f,c} (i, l) may be a positive value (e.g., increasing power) or negative value (e.g., decreasing power) respectively, or any combination). That is, the UE 205 may modify the closed loop TPC parameter by performing the additive function (e.g., adding together for the total power adjustment) to select the modified uplink transmit power level according to the closed loop TPC parameter and the closed loop transmit power adjustment.

As yet another example, the closed loop transmit power may be a function of ΔP_{b,f,c} (i, l) and f_{b,f,c} (i, l) (e.g., F(ΔP_{b,f,c} (i, l), f_{b,f,c} (i, l)). In some aspects, this may be a combination of ΔP_{b,f,c} (i, l) and f_{b,f,c} (i, l) where the closed loop transmit power={ΔP_{b,f,c} (i, l)×f_{b,f,c} (i, l)} (e.g., a multiplication function for the F( )), where the ΔP_{b,f,c} (i, l) may be used to scale f_{b,f,c} (i, l). That is, the UE 205 may modify the closed loop TPC parameter may performing a scaling function to select the modified uplink transmit power level. The scaling function may apply a scaling factor to the closed loop TPC parameter. The scaling factor in this example may be based on the closed loop transmit power adjustment. That is, the function ΔP_{b,f,c} (i, l) may be used as a scaling factor that is applied to the f_{b,f,c} (i, l) (e.g., a value smaller than one for scaling down or larger than one for scaling up).

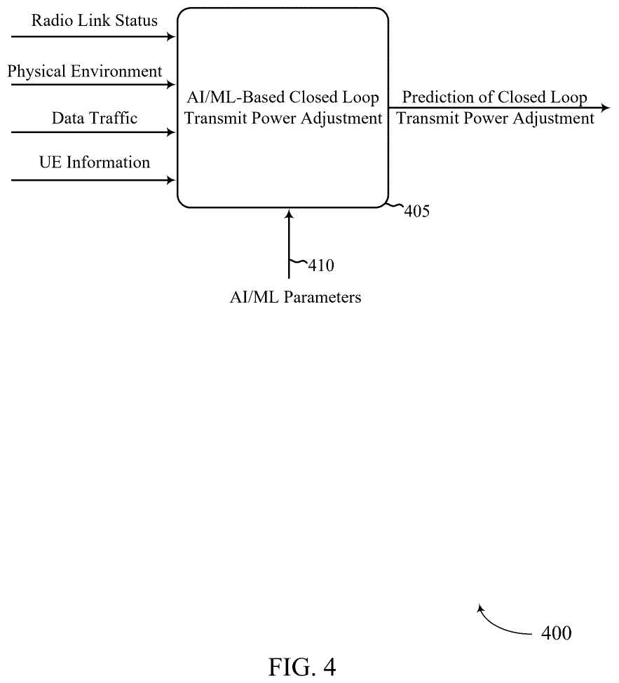

In some aspects, the techniques described herein may be based on UE capability or UE assistance information reporting from the UE 205. For example, the UE 205 may indicate its AI/ML capability or its AI/ML assistance information with closed loop transmit power adjustment and the network entity 210 may determine and configure the AI/ML based closed loop transmit power adjustment (e.g., via RRC configuration signaling) based on UE's AI/ML capability or AI/ML assistance information (e.g., via UE capability messaging or UE assistance information (UAI) messaging). In some aspects the UE 205 may transmit or otherwise output (and the network entity 210 may receive or otherwise obtain) a UE capability message (or a UAI message) that carries or otherwise conveys an indication of support for modifying the closed loop TPC parameter according to the closed loop transmit power adjustment (e.g., including UE's AI/ML capability, AI/ML model information, or the like). Accordingly, the UE 205 may receive a set of input parameters from the network entity 210 (e.g., a range ΔP_range or a value list ΔP_list or an indication of the function F(ΔP_{b,f,c} (i, l), f_{b,f,c} (i, l)) for the network to guide or manage the transmit power adjustment by the UE, the AI/ML parameters (as described in details with the connection of the reference number 410 in FIG. 4) for the network to guide or manage the AI/ML predictions, or the like) . . . .

In some aspects, the network entity 210 may further monitor and control the AI/ML-based closed loop transmit power adjustment features of the UE 205. For example, the network entity 210 may transmit or otherwise output (and the UE 205 may receive or otherwise obtain) a reconfiguration or activation message identifying one or more updates to the set of input parameters (e.g., the ΔP_range or ΔP_list, the function F(ΔP_{b,f,c} (i, l), f_{b,f,c} (i, l)), the AI/ML parameters, or the like). The UE 205 may modify the closed loop TPC parameter using the closed loop transmit power adjustment according to the update(s) to the set of input parameters. For example, this may include the network entity 210 reconfiguring (e.g., via a RRC reconfiguration message) or activating (e.g., via a MAC CE) a ΔP_range or ΔP_list, the function F(ΔP_{b,f,c} (i, l), f_{b,f,c} (i, l)), or the AI/ML input parameters (as described in details with the connection of the reference number 410 in FIG. 4) to the UE 205.

In some examples, this may include the network entity 210 transmitting or otherwise outputting (and the UE 205 receiving or otherwise obtaining) an activation message that activates or deactivates modification of the closed loop TPC parameter using the closed loop transmit power adjustment. For example, the network entity 210 may activate or deactivate (e.g., via MAC CE signaling) a ΔP_range or ΔP_list, the function F(ΔP_{b,f,c} (i, l), f_{b,f,c} (i, l)), or activate or deactivate the AI/ML model for the UE 205.

In some examples, this may include the network entity 210 transmitting or otherwise outputting (and the UE 205 receiving or otherwise obtaining) a fallback message that sets the closed loop transmit power adjustment to a baseline value. For example, the fallback position for closed loop TPC parameter modification may be set to a configured, default, or baseline value (e.g., a value of “0” for the addition function or “1” for the multiplication function for no transmit power adjustment).

In some aspects, the reconfiguration message, the activation message, or the fallback message may be based on the network entity 210 monitoring of various parameters. For example, the parameters may include the system interference level, the network throughput, the number of UEs transmitting, a received power of a transmission from a UE and the associated decoding of the transmission, or other parameters monitored or otherwise available to the network entity 210.

In some aspects, the network entity 210 may indicate (e.g., in DCI signaling) information identifying whether for one or more transmission instances the closed loop transmit power adjustment ΔP_{b,f,c} (i, l) is enabled or not (e.g., to the closed loop power control command f_{b,f,c} (i, l)), as well as the minimum or maximum value(s) of the ΔP_{b,f,c} (i, l), if enabled. For example, the network entity 210 may transmit or otherwise output (and the UE 205 may receive or otherwise obtain) a control message (e.g., DCI) that identifies one or more uplink transmission instances during which the uplink transmission is performed according to the closed loop TPC parameter and the closed loop transmit power adjustment.

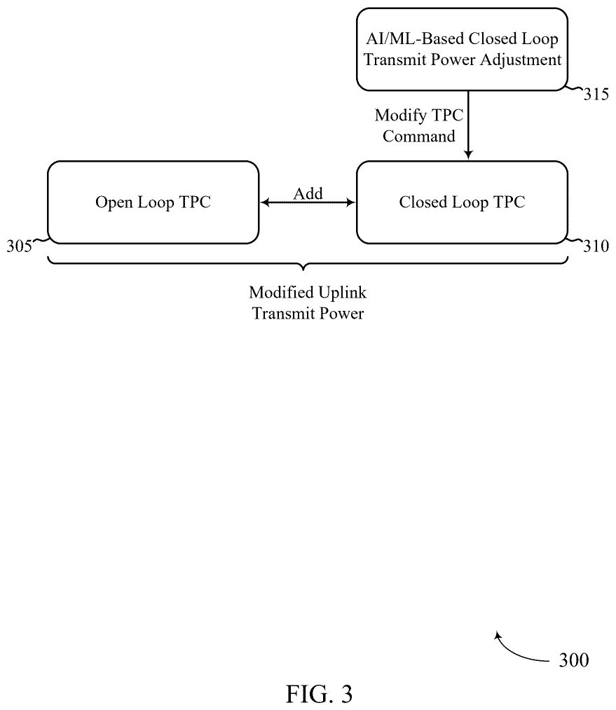

FIG. 3 shows an example of a TPC configuration 300 that supports mechanisms for AI/ML based closed loop transmit power control in accordance with one or more aspects of the present disclosure. The TPC configuration 300 may be implemented at or implemented by aspects of the wireless communications system 100 or the wireless communications system 200. For example, aspects of the TPC configuration 300 may be implemented at or implemented by a UE or a network entity, which may be examples of the corresponding devices described herein.

As discussed above, aspects of the techniques described herein provide various mechanisms for modifying a TPC command (e.g., the closed loop TPC parameter indicated in the TPC command from the network entity) based on a closed loop transmit power adjustment. For example, the network entity may transmit or otherwise output (and the UE may receive or otherwise obtain) a TPC command that identifies the closed loop TPC parameter. The closed loop TPC parameter is generally used by a UE to identify or otherwise determine the uplink transmit power level for an uplink transmission from the UE to the network entity.

However, the UE may perform the uplink transmission at a modified uplink transmit power level according to the closed loop TPC parameter and a closed loop transmit power adjustment. For example, the closed loop transmit power adjustment may be used to modify the closed loop TPC parameter to obtain the modified uplink transmit power level. The closed loop transmit power adjustment may be based on a set of input parameters.

The TPC configuration 300 illustrates an example of how the UE may use the closed loop transmit power adjustment to modify the uplink transmit power level to be used for the uplink transmission. For example, the UE may identify or otherwise determine an open loop TPC according to the term

$${α}_{b , f , c} ( j ) \cdot {PL}_{b , f , c} ( {q}_{d} ) + 10 {log}_{10} ( {2}^{μ} \cdot {M}_{RB , b , f , c}^{PUSCH} ( i ) ) + {Δ}_{TF , b , f , c} ( i )$$

referring to the open loop TPC 305. In some wireless networks, the term f_{b,f,c} (i, l) refers to the closed loop TPC (e.g., based on the closed loop TPC parameter indicated in the DC). However, the closed loop TPC 310 in this example is modified by the closed loop transmit power adjustment provided by the AI/ML-based function 315. That is, the UE may receive the closed loop TPC parameter indicated in the closed loop TPC command and also use the AI/ML-based function 315 to identify or otherwise obtain ΔP_{b,f,c} (i, l). The UE may use the output of the AI/ML-based function 315 to modify the closed loop TPC parameter, which may result in the modified closed loop transmit power level used for the uplink transmission. That is, the UE may identify or otherwise determine the closed loop transmit power level according to ΔP_{b,f,c} (i, l) and f_{b,f,c} (i, l) (e.g., F(ΔP_{b,f,c} (i, l), f_{b,f,c} (i, l))).

FIG. 4 shows an example of a TPC configuration 400 that supports mechanisms for AJ/ML based closed loop transmit power control in accordance with one or more aspects of the present disclosure. The TPC configuration 400 may be implemented at or implemented by aspects of the wireless communications system 100 or the wireless communications system 200 or aspects of the TPC configuration 300. For example, aspects of the TPC configuration 400 may be implemented at or implemented by a UE or a network entity, which may be examples of the corresponding devices described herein.

As discussed above, aspects of the techniques described herein provide various mechanisms for modifying a TPC command (e.g., the closed loop TPC parameter indicated in the TPC command from the network entity) based on a closed loop transmit power adjustment. For example, the network entity may transmit or otherwise output (and the UE may receive or otherwise obtain) a TPC command that identifies the closed loop TPC parameter. The closed loop TPC parameter is generally used by a UE to identify or otherwise determine the uplink transmit power level for an uplink transmission from the UE to the network entity.

However, the UE may perform the uplink transmission at a modified uplink transmit power level according to the closed loop TPC parameter and a closed loop transmit power adjustment. For example, the closed loop transmit power adjustment may be used to modify the closed loop TPC parameter to obtain the modified uplink transmit power level. The closed loop transmit power adjustment may be based on a set of input parameters.

The TPC configuration 400 illustrates an example of the set of input parameters that may be used to identify or otherwise determine the modified uplink transmit power level. For example, the set of input parameters may be provided into an AI/ML-based function 405 that is used by the UE and the network entity to modify the closed loop TPC parameter provided in the scheduling DCI. The output of the AI/ML-based function 405 may be the closed loop transmit power adjustment that is used to modify the closed loop TPC parameter signaled by the network entity. Broadly, the set of input parameters may include one or more of a radio link status, a physical environment parameter, a data traffic characteristics, a UE information, and one or more AI/ML parameters.

The radio link status may correspond to any information or metric associated with the radio link (e.g., the wireless channel) between the UE and the network entity. For example, the radio link status may be based on a radio link measurement or prediction (e.g., a layer 1 beam-based measurement or prediction, a layer 2 or layer 3 filtered measurement or prediction), a channel propagation (line-of-sight (LOS) or non-LOS) or fading pattern measured or predicted, an interference measured or predicted, a radio map which may indicate a distribution of signal strength across a geographic or spatial area, or any other metric identified or otherwise determined by the UE.

The physical environment parameter may correspond to any information associated with the physical environment of the UE. For example, the physical environment aspects may include static blocking or reflecting objects (e.g., buildings, structures, or trees), dynamic blocking or reflecting objects (e.g., bus or truck passing by) which may be detected or predicted, human body detection or prediction (e.g., for maximum permissible exposure (MPE) regulation), other UEs detected or predicted (e.g., for inter-UE interference), or any other information associated with the physical environment surrounding the UE (e.g., within a proximate range).

The data traffic characteristics may correspond to any data traffic features, patterns, or information related to the data being communicated between the UE and the network entity. For example, the data traffic characteristics may include statistics or prediction of data flow patterns associated with one or more QoS flows (e.g., multi-model data with different volume, latency, reliability, bursty or arrival patterns, etc.). For example, the data traffic characteristics may include statistics or prediction of energy allocation (e.g., available energy for transmission, remaining energy budget) for a communication. For example, the data traffic characteristics may include the statistics or prediction of buffer status report (BSR) or delay status report (DSR), statistics or prediction of a number of retransmissions or data drops, or any other information related to the data being communicated between the UE and the network entity.

The UE information may include any information of or relating to the UE that may impact the uplink transmission to the network entity. For example, the UE information may include information relating to the UE location, the UE orientation, the UE velocity, the UE temperature (e.g., to avoid device over heating), the UE battery level, the UE transmit power level statistics, the transmit power map which may indicate a distribution of transmit power across a geographic or spatial area, or any other information related to or otherwise associated with the UE.

The AI/ML parameters 410 may include any information that is configured or otherwise activated by the network entity for managing the AI/ML model interference. For example, the AI/ML parameters 410 may include the AI/ML model (e.g., the model architecture, bit width, lifetime span, model update cycle, accuracy requirement, misprediction or false alarm requirement, and the like), the parameters for inference or prediction of closed loop power adjustment (e.g., one or more thresholds (e.g., based on the requirements such as QoS (including reliability, latency, or data volume), energy budget or allocation, interference, or the like) or event triggering conditions (e.g., based on measured or predicted data flow or patten, energy budget, channel quality, interference level, or the like), one or more time-windows or timelines (e.g., temporal prediction with a time window or timelines), one or more counters or timers (e.g., dropped transmissions, failed decoded transmissions, or the like during a time window)), or one or more rewards (e.g., power saving rewards, interference reduction rewards, scheduling rewords) for transmit power adjustment prediction, or any other information used by the AI/ML-based function 405.

Based on the prediction of the closed loop transmit power adjustment, the UE may determine a closed loop transmit power adjustment to be applied in the connection with the close loop transmit power (TPC) command. For example, the UE may determine a transmit power adjustment based on the prediction of the transmit power adjustment (e.g., one or more adjustments with increasing or decreasing, the size of each adjustment, the time window or time lines of the one or more adjustments, or the like) and the input parameters configured or activated by the network (e.g., the ΔP_range or ΔP_list, the function F(ΔP_{b,f,c} (i, l), f_{b,f,c} (i, l)), or the like).

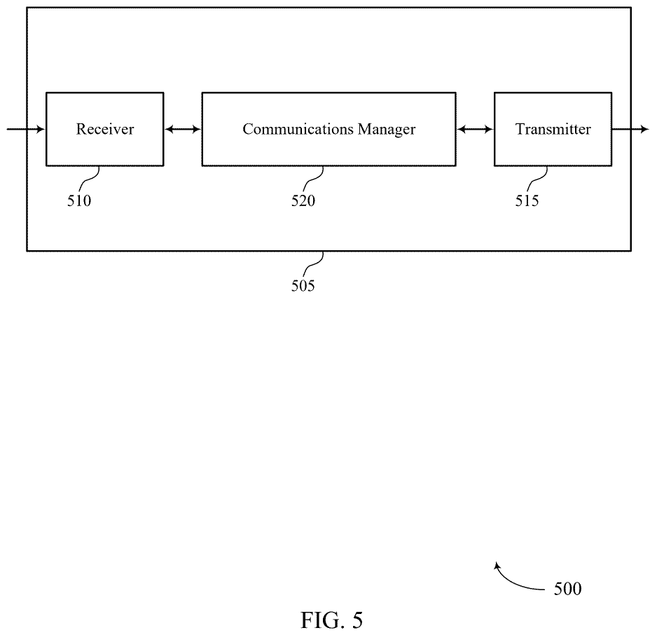

FIG. 5 shows a block diagram 500 of a device 505 that supports mechanisms for AI/ML based closed loop transmit power control in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to mechanisms for AI/ML based closed loop transmit power control). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to mechanisms for AI/ML based closed loop transmit power control). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of mechanisms for AI/ML based closed loop transmit power control as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a TPC command identifying a closed loop TPC parameter associated with an uplink transmit power level for an uplink transmission. The communications manager 520 is capable of, configured to, or operable to support a means for performing the uplink transmission at a modified uplink transmit power level according to the closed loop TPC parameter and a closed loop transmit power adjustment, where the closed loop transmit power adjustment modifies the closed loop TPC parameter according to a set of input parameters associated with the UE.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for improving closed loop TPC operations at a UE using AI/ML-based function that leverages input parameters to modify the closed loop TPC parameter indicated in the scheduling DCI.

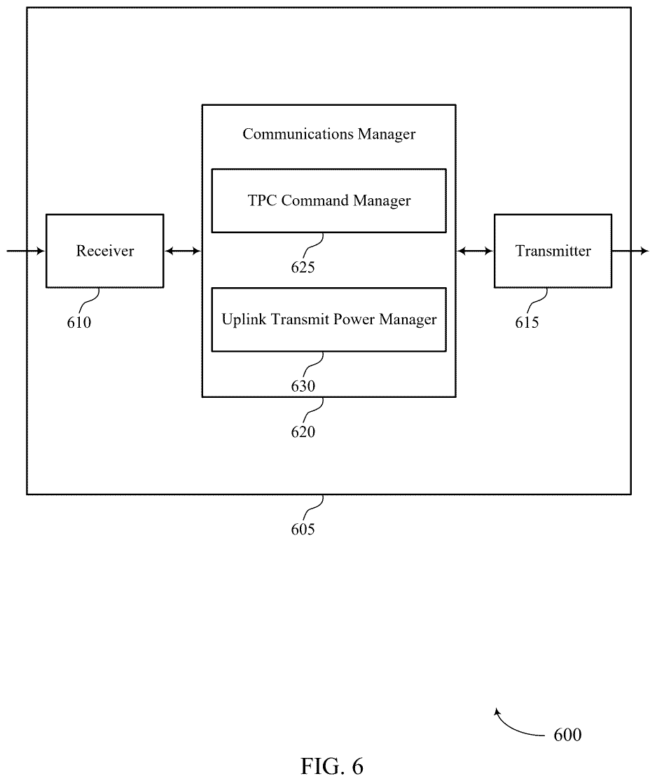

FIG. 6 shows a block diagram 600 of a device 605 that supports mechanisms for AI/ML based closed loop transmit power control in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to mechanisms for AI/ML based closed loop transmit power control). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to mechanisms for AI/ML based closed loop transmit power control). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of mechanisms for AI/ML based closed loop transmit power control as described herein. For example, the communications manager 620 may include a TPC command manager 625 an uplink transmit power manager 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The TPC command manager 625 is capable of, configured to, or operable to support a means for receiving a TPC command identifying a closed loop TPC parameter associated with an uplink transmit power level for an uplink transmission. The uplink transmit power manager 630 is capable of, configured to, or operable to support a means for performing the uplink transmission at a modified uplink transmit power level according to the closed loop TPC parameter and a closed loop transmit power adjustment, where the closed loop transmit power adjustment modifies the closed loop TPC parameter according to a set of input parameters associated with the UE.

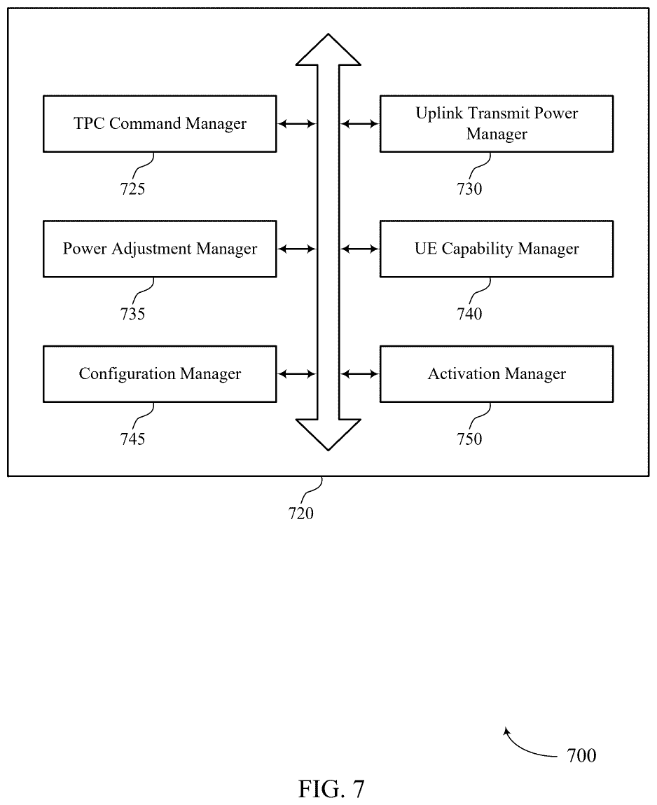

FIG. 7 shows a block diagram 700 of a communications manager 720 that supports mechanisms for AI/ML based closed loop transmit power control in accordance with one or more aspects of the present disclosure. The communications manager 720 may be an example of aspects of a communications manager 520, a communications manager 620, or both, as described herein. The communications manager 720, or various components thereof, may be an example of means for performing various aspects of mechanisms for AI/ML based closed loop transmit power control as described herein. For example, the communications manager 720 may include a TPC command manager 725, an uplink transmit power manager 730, a power adjustment manager 735, a UE capability manager 740, a configuration manager 745, an activation manager 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The TPC command manager 725 is capable of, configured to, or operable to support a means for receiving a TPC command identifying a closed loop TPC parameter associated with an uplink transmit power level for an uplink transmission. The uplink transmit power manager 730 is capable of, configured to, or operable to support a means for performing the uplink transmission at a modified uplink transmit power level according to the closed loop TPC parameter and a closed loop transmit power adjustment, where the closed loop transmit power adjustment modifies the closed loop TPC parameter according to a set of input parameters associated with the UE. In some examples, the set of input parameters include one or more of a radio link status, a physical environment parameter, a data traffic characteristics, UE information, and one or more AI/ML parameters.

In some examples, to support modifying the closed loop TPC parameter, the power adjustment manager 735 is capable of, configured to, or operable to support a means for selecting a maximum uplink transmit power level as the modified uplink transmit power level based on a function of the closed loop TPC parameter and the closed loop transmit power adjustment. In some examples, to support modifying the closed loop TPC parameter, the power adjustment manager 735 is capable of, configured to, or operable to support a means for selecting a minimum uplink transmit power level as the modified uplink transmit power level based on a function of the closed loop TPC parameter and the closed loop transmit power adjustment.

In some examples, to support modifying the closed loop TPC parameter, the power adjustment manager 735 is capable of, configured to, or operable to support a means for performing an additive function to select the modified uplink transmit power level, where the additive function is according to the closed loop TPC parameter and on the closed loop transmit power adjustment. In some examples, to support modifying the closed loop TPC parameter, the power adjustment manager 735 is capable of, configured to, or operable to support a means for performing a scaling function to select the modified uplink transmit power level, where the scaling function applies a scaling factor to the closed loop TPC parameter, where the scaling factor is based on the closed loop transmit power adjustment.

In some examples, the UE capability manager 740 is capable of, configured to, or operable to support a means for transmitting a UE capability message indicating support for modifying the closed loop TPC parameter according to the closed loop transmit power adjustment.

In some examples, the configuration manager 745 is capable of, configured to, or operable to support a means for receiving a reconfiguration or activation message identifying one or more updates to the set of input parameters, where modifying the closed loop TPC parameter is according to the one or more updates to the set of input parameters. In some examples, the configuration manager 745 is capable of, configured to, or operable to support a means for receiving a control message that identifies an uplink transmission instance during which the uplink transmission is performed according to the closed loop TPC parameter and the closed loop transmit power adjustment.

In some examples, the activation manager 750 is capable of, configured to, or operable to support a means for receiving an activation message that activates or deactivates modification of the closed loop TPC parameter using the closed loop transmit power adjustment. In some examples, the activation manager 750 is capable of, configured to, or operable to support a means for receiving a fallback message that sets the closed loop transmit power adjustment to a baseline value.

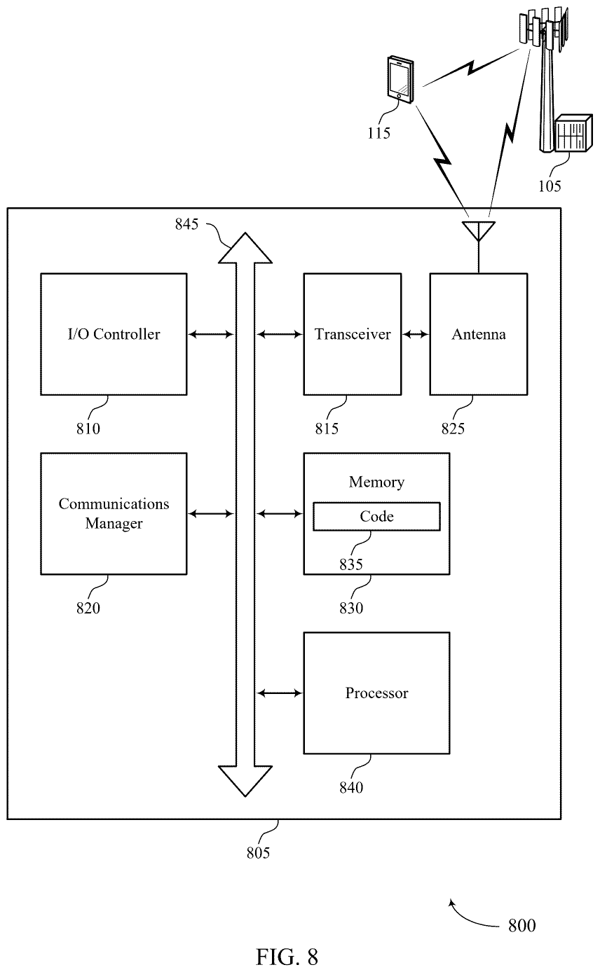

FIG. 8 shows a diagram of a system 800 including a device 805 that supports mechanisms for AI/ML based closed loop transmit power control in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting mechanisms for AI/ML based closed loop transmit power control). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a TPC command identifying a closed loop TPC parameter associated with an uplink transmit power level for an uplink transmission. The communications manager 820 is capable of, configured to, or operable to support a means for performing the uplink transmission at a modified uplink transmit power level according to the closed loop TPC parameter and a closed loop transmit power adjustment, where the closed loop transmit power adjustment modifies the closed loop TPC parameter according to a set of input parameters associated with the UE.

By including or configuring the communications manager 820 in accordance with examples as described herein, the device 805 may support techniques for improving closed loop TPC operations at a UE using AI/ML-based function that leverages input parameters to modify the closed loop TPC parameter indicated in the scheduling DCI.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of mechanisms for AI/ML based closed loop transmit power control as described herein, or the at least one processor 840 and the at least one memory 830 may be otherwise configured to, individually or collectively, perform or support such operations.

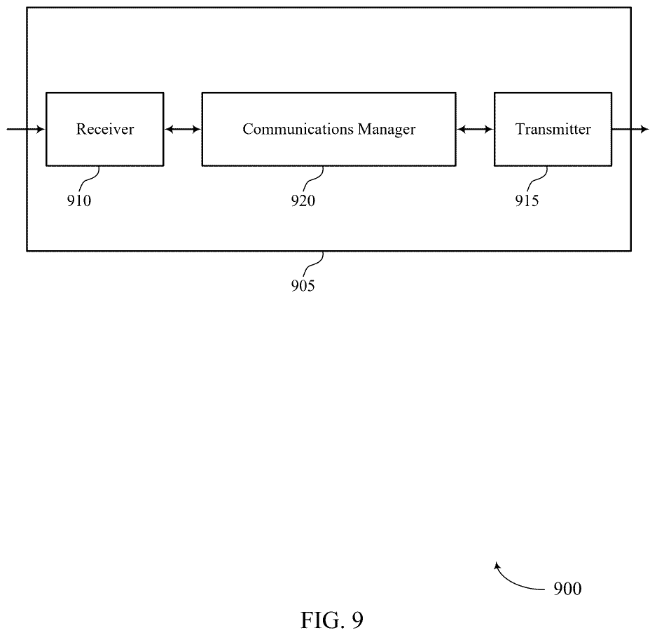

FIG. 9 shows a block diagram 900 of a device 905 that supports mechanisms for AI/ML based closed loop transmit power control in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of mechanisms for AI/ML based closed loop transmit power control as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting, to a UE, a TPC command identifying a closed loop TPC parameter associated with an uplink transmit power level for an uplink transmission from the UE. The communications manager 920 is capable of, configured to, or operable to support a means for receiving the uplink transmission transmitted at to a modified uplink transmit power level according to the closed loop TPC parameter and a closed loop transmit power adjustment, where the closed loop transmit power adjustment modifies the closed loop TPC parameter according to a set of input parameters associated with the UE.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for improving closed loop TPC operations at a UE using AI/ML-based function that leverages input parameters to modify the closed loop TPC parameter indicated in the scheduling DCI.

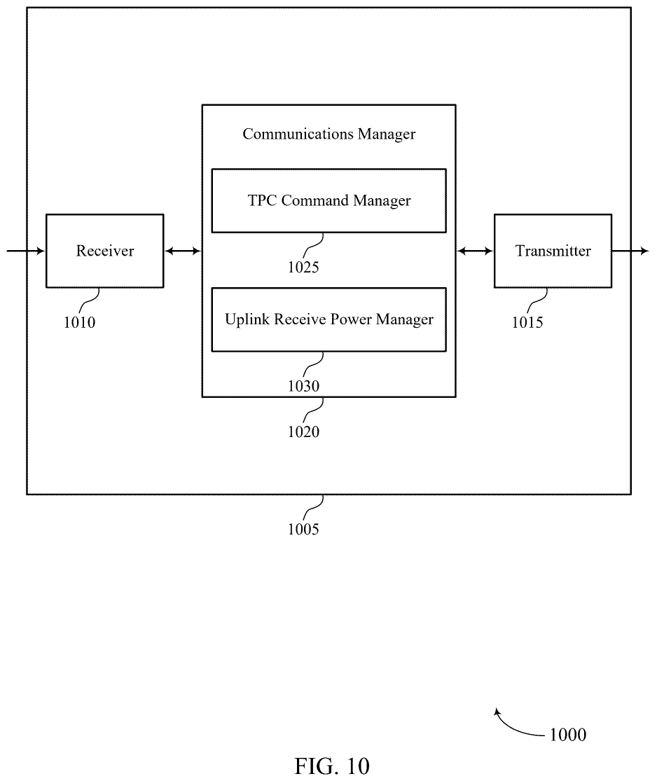

FIG. 10 shows a block diagram 1000 of a device 1005 that supports mechanisms for AI/ML based closed loop transmit power control in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one of more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of mechanisms for AI/ML based closed loop transmit power control as described herein. For example, the communications manager 1020 may include a TPC command manager 1025 an uplink receive power manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The TPC command manager 1025 is capable of, configured to, or operable to support a means for transmitting, to a UE, a TPC command identifying a closed loop TPC parameter associated with an uplink transmit power level for an uplink transmission from the UE. The uplink receive power manager 1030 is capable of, configured to, or operable to support a means for receiving the uplink transmission transmitted at to a modified uplink transmit power level according to the closed loop TPC parameter and a closed loop transmit power adjustment, where the closed loop transmit power adjustment modifies the closed loop TPC parameter according to a set of input parameters associated with the UE.

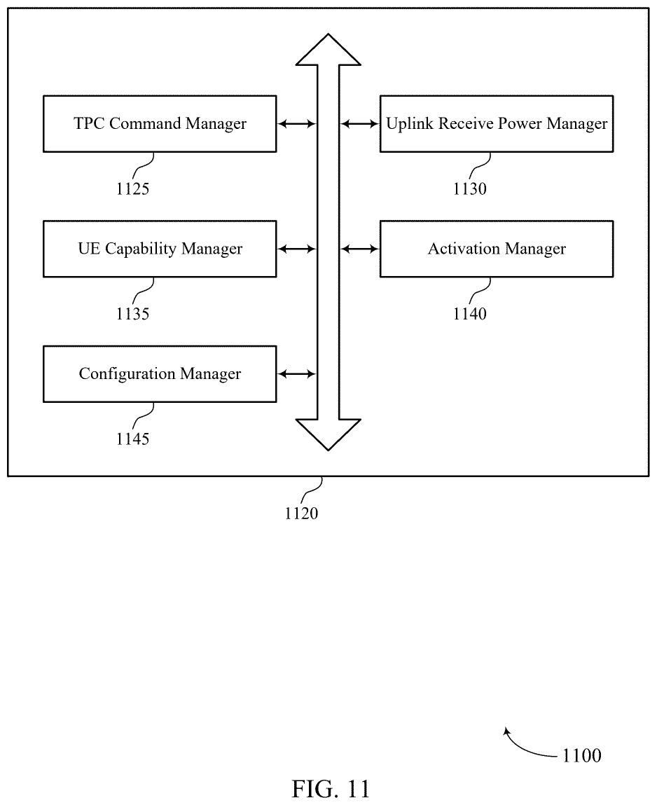

FIG. 11 shows a block diagram 1100 of a communications manager 1120 that supports mechanisms for AI/ML based closed loop transmit power control in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of mechanisms for AI/ML based closed loop transmit power control as described herein. For example, the communications manager 1120 may include a TPC command manager 1125, an uplink receive power manager 1130, a UE capability manager 1135, an activation manager 1140, a configuration manager 1145, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The TPC command manager 1125 is capable of, configured to, or operable to support a means for transmitting, to a UE, a TPC command identifying a closed loop TPC parameter associated with an uplink transmit power level for an uplink transmission from the UE. The uplink receive power manager 1130 is capable of, configured to, or operable to support a means for receiving the uplink transmission transmitted at to a modified uplink transmit power level according to the closed loop TPC parameter and a closed loop transmit power adjustment, where the closed loop transmit power adjustment modifies the closed loop TPC parameter according to a set of input parameters associated with the UE.

In some examples, the set of input parameters include one or more of a radio link status, a physical environment parameter, a data traffic characteristics, UE information, and one or more AI/ML parameters. In some examples, modification of the closed loop TPC parameter is according to a selection of a maximum uplink transmit power level as the modified uplink transmit power level based on a function of the closed loop TPC parameter and the closed loop transmit power adjustment. In some examples, modification of the closed loop TPC parameter is according to a selection of a minimum uplink transmit power level as the modified uplink transmit power level based on a function of the closed loop TPC parameter and the closed loop transmit power adjustment.

In some examples, modification of the closed loop TPC parameter is according to a performance of an additive function to select the modified uplink transmit power level. In some examples, the additive function is according to the closed loop TPC parameter and on the closed loop transmit power adjustment. In some examples, modification of the closed loop TPC parameter is according to a performance of a scaling function to select the modified uplink transmit power level. In some examples, the scaling function applies a scaling factor to the closed loop TPC parameter. In some examples, the scaling factor is based on the closed loop transmit power adjustment.

In some examples, the UE capability manager 1135 is capable of, configured to, or operable to support a means for receiving a UE capability message indicating support for modifying the closed loop TPC parameter according to the closed loop transmit power adjustment.

In some examples, the activation manager 1140 is capable of, configured to, or operable to support a means for transmitting a reconfiguration or activation message identifying one or more updates to the set of input parameters, where modifying the closed loop TPC parameter is according to the one or more updates to the set of input parameters. In some examples, the activation manager 1140 is capable of, configured to, or operable to support a means for transmitting an activation message that activates or deactivates modification of the closed loop TPC parameter using the closed loop transmit power adjustment. In some examples, the activation manager 1140 is capable of, configured to, or operable to support a means for transmitting a fallback message that sets the closed loop transmit power adjustment to a baseline value.

In some examples, the configuration manager 1145 is capable of, configured to, or operable to support a means for transmitting a control message that identifies an uplink transmission instance during which the uplink transmission is performed according to the closed loop TPC parameter and the closed loop transmit power adjustment.

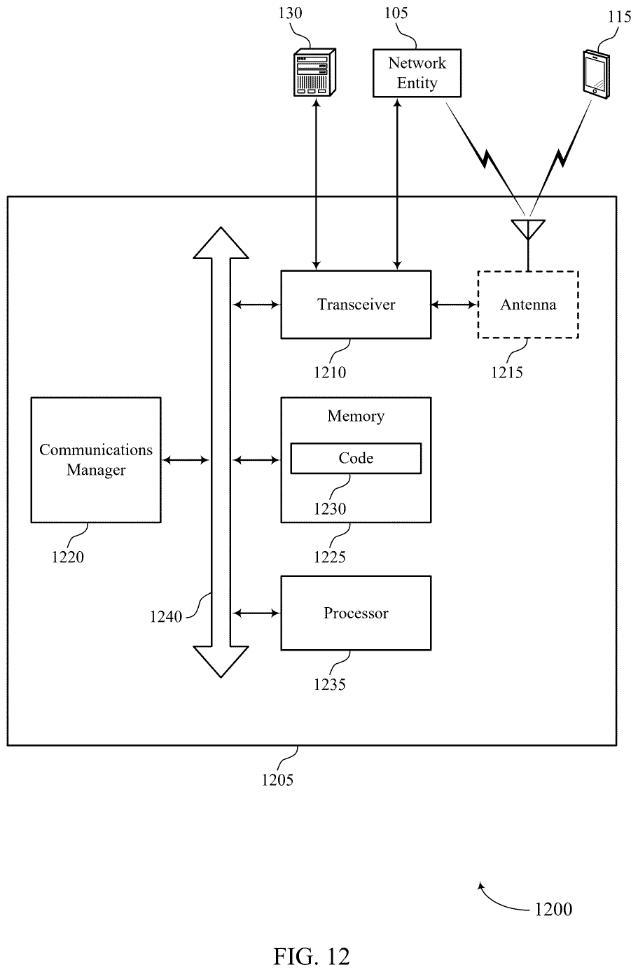

FIG. 12 shows a diagram of a system 1200 including a device 1205 that supports mechanisms for AI/ML based closed loop transmit power control in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting mechanisms for AI/ML based closed loop transmit power control). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for transmitting, to a UE, a TPC command identifying a closed loop TPC parameter associated with an uplink transmit power level for an uplink transmission from the UE. The communications manager 1220 is capable of, configured to, or operable to support a means for receiving the uplink transmission transmitted at to a modified uplink transmit power level according to the closed loop TPC parameter and a closed loop transmit power adjustment, where the closed loop transmit power adjustment modifies the closed loop TPC parameter according to a set of input parameters associated with the UE.

By including or configuring the communications manager 1220 in accordance with examples as described herein, the device 1205 may support techniques for improving closed loop TPC operations at a UE using AI/ML-based function that leverages input parameters to modify the closed loop TPC parameter indicated in the scheduling DCI.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of mechanisms for AI/ML based closed loop transmit power control as described herein, or the at least one processor 1235 and the at least one memory 1225 may be otherwise configured to, individually or collectively, perform or support such operations.

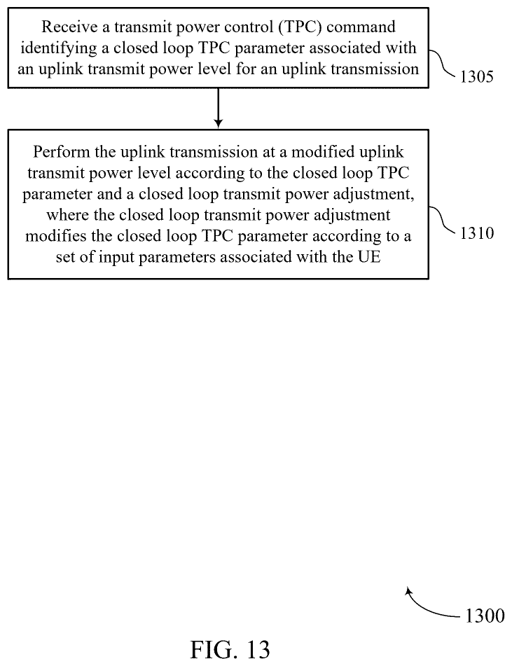

FIG. 13 shows a flowchart illustrating a method 1300 that supports mechanisms for AI/ML based closed loop transmit power control in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a TPC command identifying a closed loop TPC parameter associated with an uplink transmit power level for an uplink transmission. The operations of 1305 may be performed in accordance with examples as disclosed herein. In some examples, aspects of the operations of 1305 may be performed by a TPC command manager 725 as described with reference to FIG. 7.

At 1310, the method may include performing the uplink transmission at a modified uplink transmit power level according to the closed loop TPC parameter and a closed loop transmit power adjustment, where the closed loop transmit power adjustment modifies the closed loop TPC parameter according to a set of input parameters associated with the UE. The operations of 1310 may be performed in accordance with examples as disclosed herein. In some examples, aspects of the operations of 1310 may be performed by an uplink transmit power manager 730 as described with reference to FIG. 7.

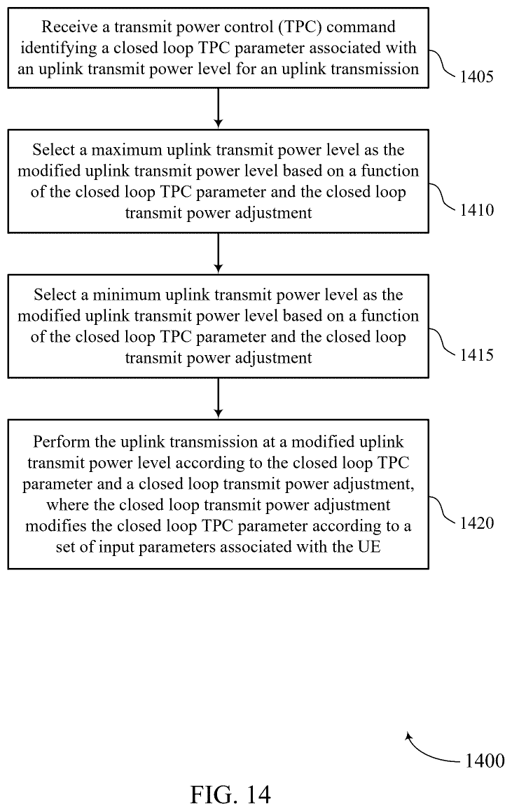

FIG. 14 shows a flowchart illustrating a method 1400 that supports mechanisms for AI/ML based closed loop transmit power control in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a TPC command identifying a closed loop TPC parameter associated with an uplink transmit power level for an uplink transmission. The operations of 1405 may be performed in accordance with examples as disclosed herein. In some examples, aspects of the operations of 1405 may be performed by a TPC command manager 725 as described with reference to FIG. 7.

At 1410, the method may include selecting a maximum uplink transmit power level as the modified uplink transmit power level based on a function of the closed loop TPC parameter and the closed loop transmit power adjustment. The operations of 1410 may be performed in accordance with examples as disclosed herein. In some examples, aspects of the operations of 1410 may be performed by a power adjustment manager 735 as described with reference to FIG. 7.

At 1415, the method may include selecting a minimum uplink transmit power level as the modified uplink transmit power level based on a function of the closed loop TPC parameter and the closed loop transmit power adjustment. The operations of 1415 may be performed in accordance with examples as disclosed herein. In some examples, aspects of the operations of 1415 may be performed by a power adjustment manager 735 as described with reference to FIG. 7.

At 1420, the method may include performing the uplink transmission at a modified uplink transmit power level according to the closed loop TPC parameter and a closed loop transmit power adjustment, where the closed loop transmit power adjustment modifies the closed loop TPC parameter according to a set of input parameters associated with the UE. The operations of 1420 may be performed in accordance with examples as disclosed herein. In some examples, aspects of the operations of 1420 may be performed by an uplink transmit power manager 730 as described with reference to FIG. 7.

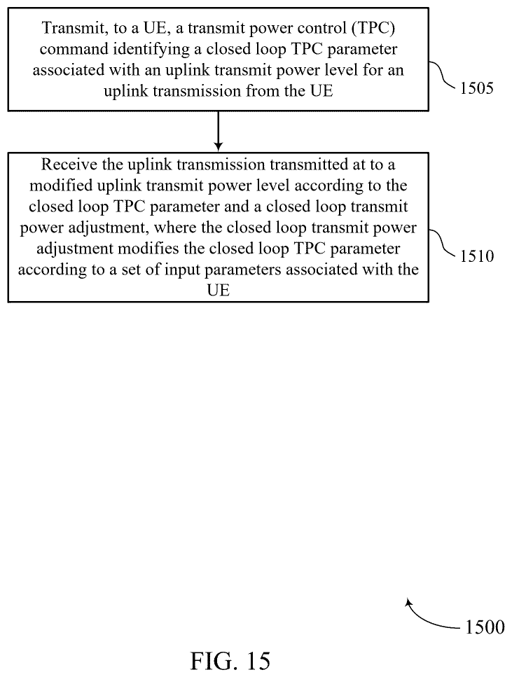

FIG. 15 shows a flowchart illustrating a method 1500 that supports mechanisms for AI/ML based closed loop transmit power control in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting, to a UE, a TPC command identifying a closed loop TPC parameter associated with an uplink transmit power level for an uplink transmission from the UE. The operations of 1505 may be performed in accordance with examples as disclosed herein. In some examples, aspects of the operations of 1505 may be performed by a TPC command manager 1125 as described with reference to FIG. 11.

At 1510, the method may include receiving the uplink transmission transmitted at to a modified uplink transmit power level according to the closed loop TPC parameter and a closed loop transmit power adjustment, where the closed loop transmit power adjustment modifies the closed loop TPC parameter according to a set of input parameters associated with the UE. The operations of 1510 may be performed in accordance with examples as disclosed herein. In some examples, aspects of the operations of 1510 may be performed by an uplink receive power manager 1130 as described with reference to FIG. 11.

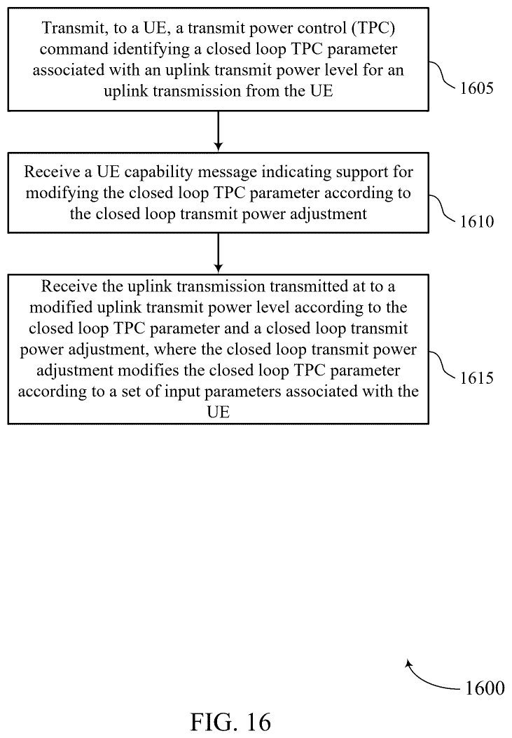

FIG. 16 shows a flowchart illustrating a method 1600 that supports mechanisms for AI/ML based closed loop transmit power control in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, to a UE, a TPC command identifying a closed loop TPC parameter associated with an uplink transmit power level for an uplink transmission from the UE. The operations of 1605 may be performed in accordance with examples as disclosed herein. In some examples, aspects of the operations of 1605 may be performed by a TPC command manager 1125 as described with reference to FIG. 11.

At 1610, the method may include receiving a UE capability message indicating support for modifying the closed loop TPC parameter according to the closed loop transmit power adjustment. The operations of 1610 may be performed in accordance with examples as disclosed herein. In some examples, aspects of the operations of 1610 may be performed by a UE capability manager 1135 as described with reference to FIG. 11.

At 1615, the method may include receiving the uplink transmission transmitted at to a modified uplink transmit power level according to the closed loop TPC parameter and a closed loop transmit power adjustment, where the closed loop transmit power adjustment modifies the closed loop TPC parameter according to a set of input parameters associated with the UE. The operations of 1615 may be performed in accordance with examples as disclosed herein. In some examples, aspects of the operations of 1615 may be performed by an uplink receive power manager 1130 as described with reference to FIG. 11.

The following provides an overview of aspects of the present disclosure:

Aspect 1: A method for wireless communications at a UE, comprising: receiving a TPC command identifying a closed loop TPC parameter associated with an uplink transmit power level for an uplink transmission; and performing the uplink transmission at a modified uplink transmit power level according to the closed loop TPC parameter and a closed loop transmit power adjustment, wherein the closed loop transmit power adjustment modifies the closed loop TPC parameter according to a set of input parameters associated with the UE.

Aspect 2: The method of aspect 1, wherein the set of input parameters include one or more of a radio link status, a physical environment parameter, a data traffic characteristics, UE information, and one or more AI/ML parameters.

Aspect 3: The method of any of aspects 1 through 2, wherein modifying the closed loop TPC parameter comprises: selecting a maximum uplink transmit power level as the modified uplink transmit power level based on a function of the closed loop TPC parameter and the closed loop transmit power adjustment.

Aspect 4: The method of any of aspects 1 through 3, wherein modifying the closed loop TPC parameter comprises: selecting a minimum uplink transmit power level as the modified uplink transmit power level based on a function of the closed loop TPC parameter and the closed loop transmit power adjustment.

Aspect 5: The method of any of aspects 1 through 4, wherein modifying the closed loop TPC parameter comprises: performing an additive function to select the modified uplink transmit power level, wherein the additive function is according to the closed loop TPC parameter and on the closed loop transmit power adjustment.

Aspect 6: The method of any of aspects 1 through 5, wherein modifying the closed loop TPC parameter comprises: performing a scaling function to select the modified uplink transmit power level, wherein the scaling function applies a scaling factor to the closed loop TPC parameter, wherein the scaling factor is based on the closed loop transmit power adjustment.

Aspect 7: The method of any of aspects 1 through 6, further comprising: transmitting a UE capability message indicating support for modifying the closed loop TPC parameter according to the closed loop transmit power adjustment.

Aspect 8: The method of any of aspects 1 through 7, further comprising: receiving a reconfiguration or activation message identifying one or more updates to the set of input parameters, wherein modifying the closed loop TPC parameter is according to the one or more updates to the set of input parameters.

Aspect 9: The method of any of aspects 1 through 8, further comprising: receiving an activation message that activates or deactivates modification of the closed loop TPC parameter using the closed loop transmit power adjustment.

Aspect 10: The method of any of aspects 1 through 9, further comprising: receiving a fallback message that sets the closed loop transmit power adjustment to a baseline value.

Aspect 11: The method of any of aspects 1 through 10, further comprising: receiving a control message that identifies an uplink transmission instance during which the uplink transmission is performed according to the closed loop TPC parameter and the closed loop transmit power adjustment.

Aspect 12: A method for wireless communications at a network entity, comprising: transmitting, to a UE, a TPC command identifying a closed loop TPC parameter associated with an uplink transmit power level for an uplink transmission from the UE; and receiving the uplink transmission transmitted at to a modified uplink transmit power level according to the closed loop TPC parameter and a closed loop transmit power adjustment, wherein the closed loop transmit power adjustment modifies the closed loop TPC parameter according to a set of input parameters associated with the UE.

Aspect 13: The method of aspect 12, wherein the set of input parameters include one or more of a radio link status, a physical environment parameter, a data traffic characteristics, UE information, and one or more AI/ML parameters.

Aspect 14: The method of any of aspects 12 through 13, wherein modification of the closed loop TPC parameter is according to a selection of a maximum uplink transmit power level as the modified uplink transmit power level based on a function of the closed loop TPC parameter and the closed loop transmit power adjustment.

Aspect 15: The method of any of aspects 12 through 14, wherein modification of the closed loop TPC parameter is according to a selection of a minimum uplink transmit power level as the modified uplink transmit power level based on a function of the closed loop TPC parameter and the closed loop transmit power adjustment.

Aspect 16: The method of any of aspects 12 through 15, wherein modification of the closed loop TPC parameter is according to a performance of an additive function to select the modified uplink transmit power level, the additive function is according to the closed loop TPC parameter and on the closed loop transmit power adjustment.

Aspect 17: The method of any of aspects 12 through 16, wherein modification of the closed loop TPC parameter is according to a performance of a scaling function to select the modified uplink transmit power level, the scaling function applies a scaling factor to the closed loop TPC parameter, the scaling factor is based on the closed loop transmit power adjustment.

Aspect 18: The method of any of aspects 12 through 17, further comprising: receiving a UE capability message indicating support for modifying the closed loop TPC parameter according to the closed loop transmit power adjustment.

Aspect 19: The method of any of aspects 12 through 18, further comprising: transmitting a reconfiguration or activation message identifying one or more updates to the set of input parameters, wherein modifying the closed loop TPC parameter is according to the one or more updates to the set of input parameters.

Aspect 20: The method of any of aspects 12 through 19, further comprising: transmitting an activation message that activates or deactivates modification of the closed loop TPC parameter using the closed loop transmit power adjustment.

Aspect 21: The method of any of aspects 12 through 20, further comprising: transmitting a fallback message that sets the closed loop transmit power adjustment to a baseline value.

Aspect 22: The method of any of aspects 12 through 21, further comprising: transmitting a control message that identifies an uplink transmission instance during which the uplink transmission is performed according to the closed loop TPC parameter and the closed loop transmit power adjustment.

Aspect 23: A UE for wireless communications, comprising one or more memories storing processor-executable code, and one or more processors coupled with the one or more memories and individually or collectively operable to execute the code to cause the UE to perform a method of any of aspects 1 through 11.

Aspect 24: A UE for wireless communications, comprising at least one means for performing a method of any of aspects 1 through 11.

Aspect 25: A non-transitory computer-readable medium storing code for wireless communications, the code comprising instructions executable by one or more processors to perform a method of any of aspects 1 through 11.

Aspect 26: A network entity for wireless communications, comprising one or more memories storing processor-executable code, and one or more processors coupled with the one or more memories and individually or collectively operable to execute the code to cause the network entity to perform a method of any of aspects 12 through 22.

Aspect 27: A network entity for wireless communications, comprising at least one means for performing a method of any of aspects 12 through 22.

Aspect 28: A non-transitory computer-readable medium storing code for wireless communications, the code comprising instructions executable by one or more processors to perform a method of any of aspects 12 through 22.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The term “set” may one or more items in the set. The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more processors; and
instructions stored in one or more memories and executable by the one or more processors, individually or collectively, to cause the UE to:
receive a transmit power control (TPC) command identifying a closed loop TPC parameter associated with an uplink transmit power level for an uplink transmission; and
perform the uplink transmission at a modified uplink transmit power level according to the closed loop TPC parameter and a closed loop transmit power adjustment, wherein the closed loop transmit power adjustment modifies the closed loop TPC parameter according to a set of input parameters associated with the UE.

2. The UE of claim 1, wherein the set of input parameters include one or more of a radio link status, a physical environment parameter, a data traffic characteristics, UE information, and one or more artificial intelligence/machine learning (AI/ML) parameters.

3. The UE of claim 1, wherein, to modify the closed loop TPC parameter, the instructions are executable by the one or more processors, individually or collectively, to cause the UE to:
select a maximum uplink transmit power level as the modified uplink transmit power level based on a function of the closed loop TPC parameter and the closed loop transmit power adjustment.

4. The UE of claim 1, wherein, to modify the closed loop TPC parameter, the instructions are executable by the one or more processors, individually or collectively, to cause the UE to:
select a minimum uplink transmit power level as the modified uplink transmit power level based on a function of the closed loop TPC parameter and the closed loop transmit power adjustment.

5. The UE of claim 1, wherein, to modify the closed loop TPC parameter, the instructions are executable by the one or more processors, individually or collectively, to cause the UE to:
perform an additive function to select the modified uplink transmit power level, wherein the additive function is according to the closed loop TPC parameter and on the closed loop transmit power adjustment.

6. The UE of claim 1, wherein, to modify the closed loop TPC parameter, the instructions are executable by the one or more processors, individually or collectively, to cause the UE to:
perform a scaling function to select the modified uplink transmit power level, wherein the scaling function applies a scaling factor to the closed loop TPC parameter, wherein the scaling factor is based on the closed loop transmit power adjustment.

7. The UE of claim 1, wherein the instructions are executable by the one or more processors, individually or collectively, to cause the UE to:
transmit a UE capability message indicating support for modifying the closed loop TPC parameter according to the closed loop transmit power adjustment.

8. The UE of claim 1, wherein the instructions are executable by the one or more processors, individually or collectively, to cause the UE to:
receive a reconfiguration or activation message identifying one or more updates to the set of input parameters, wherein modifying the closed loop TPC parameter is according to the one or more updates to the set of input parameters.

9. The UE of claim 1, wherein the instructions are executable by the one or more processors, individually or collectively, to cause the UE to:
receive an activation message that activates or deactivates modification of the closed loop TPC parameter using the closed loop transmit power adjustment.

10. The UE of claim 1, wherein the instructions are executable by the one or more processors, individually or collectively, to cause the UE to:
receive a fallback message that sets the closed loop transmit power adjustment to a baseline value.

11. The UE of claim 1, wherein the instructions are executable by the one or more processors, individually or collectively, to cause the UE to:
receive a control message that identifies an uplink transmission instance during which the uplink transmission is performed according to the closed loop TPC parameter and the closed loop transmit power adjustment.

12. A network entity, comprising:
one or more processors; and
instructions stored in one or more memories and executable by the one or more processors, individually or collectively, to cause the network entity to:
transmit, to a user equipment (UE), a transmit power control (TPC) command identifying a closed loop TPC parameter associated with an uplink transmit power level for an uplink transmission from the UE; and
receive the uplink transmission transmitted at to a modified uplink transmit power level according to the closed loop TPC parameter and a closed loop transmit power adjustment, wherein the closed loop transmit power adjustment modifies the closed loop TPC parameter according to a set of input parameters associated with the UE.

13. The network entity of claim 12, wherein the set of input parameters include one or more of a radio link status, a physical environment parameter, a data traffic characteristics, UE information, and one or more artificial intelligence/machine learning (AI/ML) parameters.

14. The network entity of claim 12, wherein modification of the closed loop TPC parameter is according to a selection of a maximum uplink transmit power level as the modified uplink transmit power level based on a function of the closed loop TPC parameter and the closed loop transmit power adjustment.

15. The network entity of claim 12, wherein modification of the closed loop TPC parameter is according to a selection of a minimum uplink transmit power level as the modified uplink transmit power level based on a function of the closed loop TPC parameter and the closed loop transmit power adjustment.

16. The network entity of claim 12, wherein:
modification of the closed loop TPC parameter is according to a performance of an additive function to select the modified uplink transmit power level, and
the additive function is according to the closed loop TPC parameter and on the closed loop transmit power adjustment.

17. The network entity of claim 12, wherein:
modification of the closed loop TPC parameter is according to a performance of a scaling function to select the modified uplink transmit power level,
the scaling function applies a scaling factor to the closed loop TPC parameter, and
the scaling factor is based on the closed loop transmit power adjustment.

18. The network entity of claim 12, wherein the instructions are executable by the one or more processors, individually or collectively, to cause the network entity to:
receive a UE capability message indicating support for modifying the closed loop TPC parameter according to the closed loop transmit power adjustment.

19. The network entity of claim 12, wherein the instructions are executable by the one or more processors, individually or collectively, to cause the network entity to:
transmit a reconfiguration or activation message identifying one or more updates to the set of input parameters, wherein modifying the closed loop TPC parameter is according to the one or more updates to the set of input parameters.

20. The network entity of claim 12, wherein the instructions are executable by the one or more processors, individually or collectively, to cause the network entity to:
transmit an activation message that activates or deactivates modification of the closed loop TPC parameter using the closed loop transmit power adjustment.

21. The network entity of claim 12, wherein the instructions are executable by the one or more processors, individually or collectively, to cause the network entity to:
transmit a fallback message that sets the closed loop transmit power adjustment to a baseline value.

22. The network entity of claim 12, wherein the instructions are executable by the one or more processors, individually or collectively, to cause the network entity to:
transmit a control message that identifies an uplink transmission instance during which the uplink transmission is performed according to the closed loop TPC parameter and the closed loop transmit power adjustment.

23. A method for wireless communications at a user equipment (UE), comprising:
receiving a transmit power control (TPC) command identifying a closed loop TPC parameter associated with an uplink transmit power level for an uplink transmission; and
performing the uplink transmission at a modified uplink transmit power level according to the closed loop TPC parameter and a closed loop transmit power adjustment, wherein the closed loop transmit power adjustment modifies the closed loop TPC parameter according to a set of input parameters associated with the UE.

24. The method of claim 23, wherein the set of input parameters include one or more of a radio link status, a physical environment parameter, a data traffic characteristics, UE information, and one or more artificial intelligence/machine learning (AI/ML) parameters.

25. The method of claim 23, wherein modifying the closed loop TPC parameter comprises:
selecting a maximum uplink transmit power level as the modified uplink transmit power level based on a function of the closed loop TPC parameter and the closed loop transmit power adjustment.

26. The method of claim 23, wherein modifying the closed loop TPC parameter comprises:
selecting a minimum uplink transmit power level as the modified uplink transmit power level based on a function of the closed loop TPC parameter and the closed loop transmit power adjustment.

27. The method of claim 23, wherein modifying the closed loop TPC parameter comprises:
performing an additive function to select the modified uplink transmit power level, wherein the additive function is according to the closed loop TPC parameter and on the closed loop transmit power adjustment.

28. The method of claim 23, wherein modifying the closed loop TPC parameter comprises:
performing a scaling function to select the modified uplink transmit power level, wherein the scaling function applies a scaling factor to the closed loop TPC parameter, wherein the scaling factor is based on the closed loop transmit power adjustment.

29. The method of claim 23, further comprising:
transmitting a UE capability message indicating support for modifying the closed loop TPC parameter according to the closed loop transmit power adjustment.

30. A method for wireless communications at a network entity, comprising:
transmitting, to a user equipment (UE), a transmit power control (TPC) command identifying a closed loop TPC parameter associated with an uplink transmit power level for an uplink transmission from the UE; and
receiving the uplink transmission transmitted at to a modified uplink transmit power level according to the closed loop TPC parameter and a closed loop transmit power adjustment, wherein the closed loop transmit power adjustment modifies the closed loop TPC parameter according to a set of input parameters associated with the UE.
